(19) United States
(12) Patent Application Publication
(10) Pub. No.: US 2002/0002609 A1
(43) Pub. Date: Jan. 3, 2002

(54) Telecommunications operating system

(76) Inventors: David W. Chung, San Pedro, CA (US); Sae Joon Kim, Pico Rivera, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/752,808

(22) Filed: Dec. 28, 2000

Related U.S. Application Data
(60) Provisional application No. 60/246,166, filed on Nov. 6, 2000.

(30) Foreign Application Priority Data
Dec. 29, 1999 (KR) 99-64911

(51) Int. Cl. G06F 15/173

(52) U.S. Cl. 709/223; 709/225

(57) ABSTRACT

The present invention is related to methods and apparatus that provide an Internet telecommunications operating system (iTOS) that provides software developers with an intermediate layer to assist in the development of telecommunications applications for the Internet. One embodiment of the present invention includes APIs adapted to communicate with the underlying general operating system and the underlying hardware such that a higher-level application written for use with the iTOS is portable. The iTOS automatically detects and allocates locally and remotely available hardware resources, thereby insulating the higher-level application from having to search and detect hardware. In addition, the iTOS can further include redundancy features, such as the dynamic reallocation of resources and the automatic reconfiguration of malfunctioning or overloaded hardware, thereby enhancing the robustness of a related telecommunications network as a whole.

### RELATED APPLICATIONS

This application claims the benefit under 35 U.S.C. § 119(e) of U.S. Provisional Application No. 60/246,166, filed Nov. 06, 2000, the entirety of which is hereby incorporated by reference.

This application also claims the benefit under 35 U.S.C. § 119(a) of Korean Patent Application No. F19C019, filed Dec. 29, 1999.

### BACKGROUND OF THE INVENTION

1. Field of the Invention

The present invention generally relates to computer systems. In particular, the present invention relates to Internet telecommunications.

2. Description of the Related Art

The public's access to the Internet has grown more commonplace and more convenient over the years. Services traditionally offered only through a Public Switched Telephone Network (PSTN), such as a plain old telephone service (POTS), can now be carried by the Internet through protocols such as Voice over Internet Protocol (VoIP), Fax over Internet Protocol (FoIP), and Unified Message Systems (UMS).

General purpose operating systems, such as Microsoft® Windows® NT, provide little support for Internet telecommunications. As a result, conventional software packages that provide users with telecommunications services over the Internet tend to be incompatible with each other, support relatively few hardware options, are relatively difficult to develop and support, and are relatively difficult to maintain in the face of hardware changes. In fact, in a conventional system with multiple software for various telecommunications related applications, each software application is often upgraded whenever a hardware component, such as a peripheral card, is upgraded. The process of upgrading software to conform to new hardware can be a tedious and time-consuming task, which is made particularly difficult when software updates are not supported by the software vendor.

### SUMMARY OF THE INVENTION

Embodiments of the present invention advantageously allow software developers to quickly and conveniently develop Internet telecommunications applications by providing a telephony or telecommunications operating system layer that communicates with an Internet telecommunications application or other communication application and the underlying hardware and/or general operating system. Embodiments of the present invention allow for expanded portability of the telecommunications application across a broad range of general operating systems and hardware.

One embodiment of the present invention includes application program interfaces (APIs) and other protocols adapted to communicate with the underlying general operating system and the underlying hardware such that a higher-level application written for use with the Internet Telecommunications Operating System (iTOS) is portable. The iTOS automatically detects and allocates locally and remotely available hardware resources, thereby insulating the higher-level application from having to search and detect hardware. In addition, the iTOS can further include redundancy features, such as the dynamic reallocation of resources and the automatic reconfiguration of malfunctioning or overloaded hardware, thereby enhancing the overall robustness of a related telecommunications network.

One embodiment of the present invention includes a method that authenticates a user by a login process, retrieves an account associated with the user, automatically detects telecommunications resources present, and combines the related telecommunications resources into resource pools. The method further establishes communication with remote systems such that the systems can share resources, and allows a user to access a telecommunications application, where the telecommunications application communicates with underlying hardware through application program interfaces. The application program interfaces and the virtual pools insulate the telecommunications applications from managing hardware and resources and from reconfigurations due to changes, upgrades, and expansions of underlying hardware by providing the telecommunications applications with an intermediate interface. The resource pools are allocated or shared among the telecommunications applications. In one embodiment, the resources are dynamically re-allocated in response to changes in demand on those resources. In addition, where locally available resources are insufficient, resources from remote systems can be shared so that the telecommunications application can continue to function without substantial interruption.

One embodiment according to the present invention includes an Internet telecommunications operating system with a system integration layer, a telecommunications service application layer, and a telecommunications operating system layer. The Internet telecommunications operating system works in conjunction with an existing operating system, such as Windows® NT. The system integration layer communicates with the underlying hardware and the general operating system, and further arranges available resources into resource pools. The telecommunications service application layer communicates with the higher-level telecommunications applications accessible by the user through APIs and the like, advantageously enhancing the portability and supportability of the telecommunications application by relying on the system integration layer to communicate with the underlying hardware as necessary. The telecommunications operating system layer further coordinates data transfers to and from the system integration layer and the telecommunications service application layer, and distributes resources to the telecommunications applications. The telecommunications operating system layer further monitors the transactions, or the data transferred, which can be collected and used to generate billing reports, system status, and the like.

### BRIEF DESCRIPTION OF THE DRAWINGS

These and other features of the invention will now be described with reference to the drawings summarized below. These drawings and the associated description are provided to illustrate preferred embodiments of the invention, and not to limit the scope of the invention.

FIG. 1A illustrates telecommunications implemented with computers.

FIG. 1B illustrates an exemplary system, including hardware and software components, according to one embodiment of the present invention.

FIG. 2 illustrates one top-level organization of an Internet Telecommunications Operating System (iTOS) according to an embodiment of the present invention.

FIG. 3 illustrates Internet telecommunications hardware and a system integration layer.

FIG. 4 illustrates a telecommunications operating system layer.

FIG. 5 illustrates a telecommunications service applications layer.

FIG. 6 illustrates an overview process according to one embodiment of the present invention.

### DETAILED DESCRIPTION OF PREFERRED EMBODIMENTS

Although this invention will be described in terms of certain preferred embodiments, other embodiments that are apparent to those of ordinary skill in the art, including embodiments which do not provide all of the benefits and features set forth herein, are also within the scope of this invention. Accordingly, the scope of the present invention is defined only by reference to the appended claims.

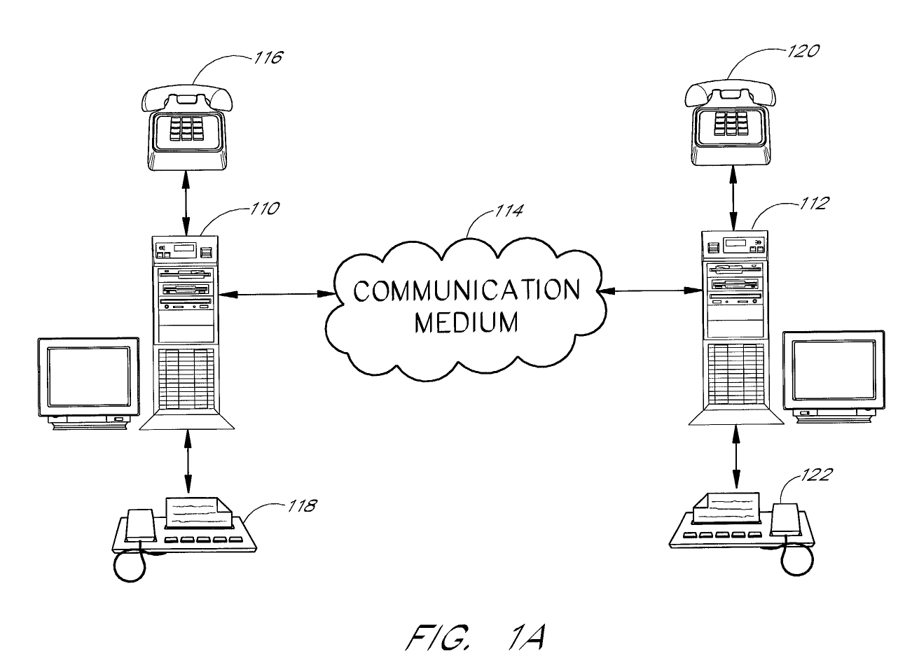

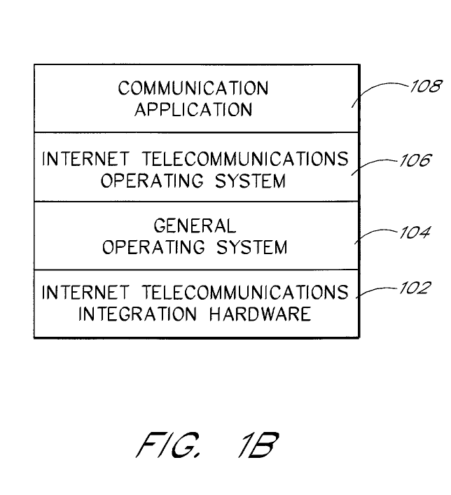

FIG. 1A illustrates telecommunications implemented with computers. A first computer system 110 communicates with a second computer system 112 via a communication medium 114, such as the Internet. The first computer system further includes interfaces to a telephone 116 or similar device, and to a facsimile device 118. Of course, the first computer system can include other devices useful for telecommunications, such as video cameras, scanners, and the like. The second computer system also includes interfaces to a telephone 120 or similar device, and to a facsimile 122.

Embodiments of the present invention include an Internet Telecommunications Operating System (iTOS), which advantageously allows software developers to develop telecommunications applications for the Internet with less effort and with minimal knowledge of the underlying telecommunications hardware on which the telecommunications applications operate as compared to conventional systems. The telecommunications application communicates with the iTOS through an application program interface (API), rather than directly with the telecommunications hardware, thereby insulating the application from the telecommunications hardware and enhancing the portability of the telecommunications application. The iTOS also eases scaling and/or upgrading of related telecommunications hardware by accommodating the software updates for the changed hardware merely at the iTOS level, rather than updating the communication application resident on the hardware.

In one embodiment, where two disparate systems both communicate via the iTOS, the two disparate systems can communicate via the iTOS to share resources, thereby advantageously enhancing the efficiency of the systems as a whole.

FIG. 1B illustrates an exemplary system 100, with hardware and software components, according to one embodiment of the present invention. The illustrated system 100 includes hardware, such as the Internet Telecommunications Integration (ITI) hardware 102. The ITI hardware 102 includes standard computers, such as personal computers and laptops, configured to allow access to the Internet. The ITI hardware 102 can include modems, sound cards, video capture cards, network cards, and the like.

The illustrated system 100 further includes a general operating system 104, an Internet telecommunications operating system (iTOS) 106, and a communication application 108. The general operating system 104 includes operating systems such as Microsoft® Windows® 3.1, Microsoft® Windows® 95, Microsoft® Windows® 98, Microsoft® Windows® NT, Microsoft® Windows® 2000, Microsoft® Windows® Me, Sun™ Solaris™, Unix®, Red Hat® Linux, and others.

The iTOS 106 and the communication application 108 work in conjunction with the general operating system 104 and the ITI 102 to provide the user with Internet telecommunications. The iTOS 106 handles basic communications tasks, such as input/output, between the communication application 108 and the general operating system 104. This advantageously allows a programmer to develop the communication application 108 from an application program interface (API), which includes predetermined routines, protocols, tools, and the like that allow the communication application 108 to be developed simply and efficiently.

A further advantage of the iTOS 106 is that an upgrade to the ITI 102 does not require a corresponding update or reconfiguration of the communication application 108. Rather, the communication application 108 continues to communicate with the iTOS 106 in the same manner as prior to the upgrade, and the iTOS 106 is updated as necessary, via a driver and the like, for compatibility with the newly configured hardware. This allows the user to advantageously upgrade only a single platform, namely the iTOS 106, rather than reconfigure multiple communication applications 108.

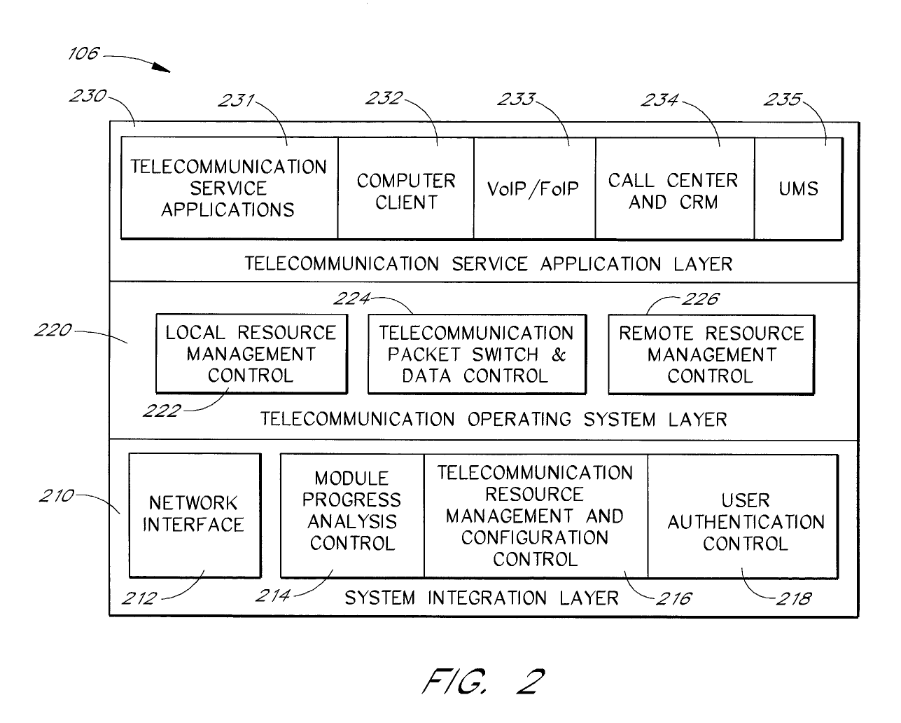

FIG. 2 illustrates an organization of one embodiment according to the present invention of the iTOS 106. The illustrated iTOS 106 includes a System Integration (SI) layer 210, a Telecommunications Operating System (TOS) layer 220, and a Telecommunications Service Application (TSA) layer 230.

In the illustrated iTOS 106, the SI layer 210 is the lowest-level layer of the iTOS 106. The SI layer 210 controls and communicates with the mounted telecommunication hardware and other peripherals. Examples of such hardware include mass storage devices, memory, network interface cards (NIC), Asynchronous Transfer Mode (ATM) adapters, signal processors and the like.

The SI layer 210 includes a Network Interface 212, a Module Progress Analysis (MPA) Control 214, a Telecommunication Resource Management and Configuration (TRMC) Control 216 and a User Authentication (UA) Control 218. The Network Interface 212 communicates with the resident NICs, such as adapters to T-1, E1, ATM, integrated services digital network (ISDN), digital subscriber line (DSL), and signaling system (SS7).

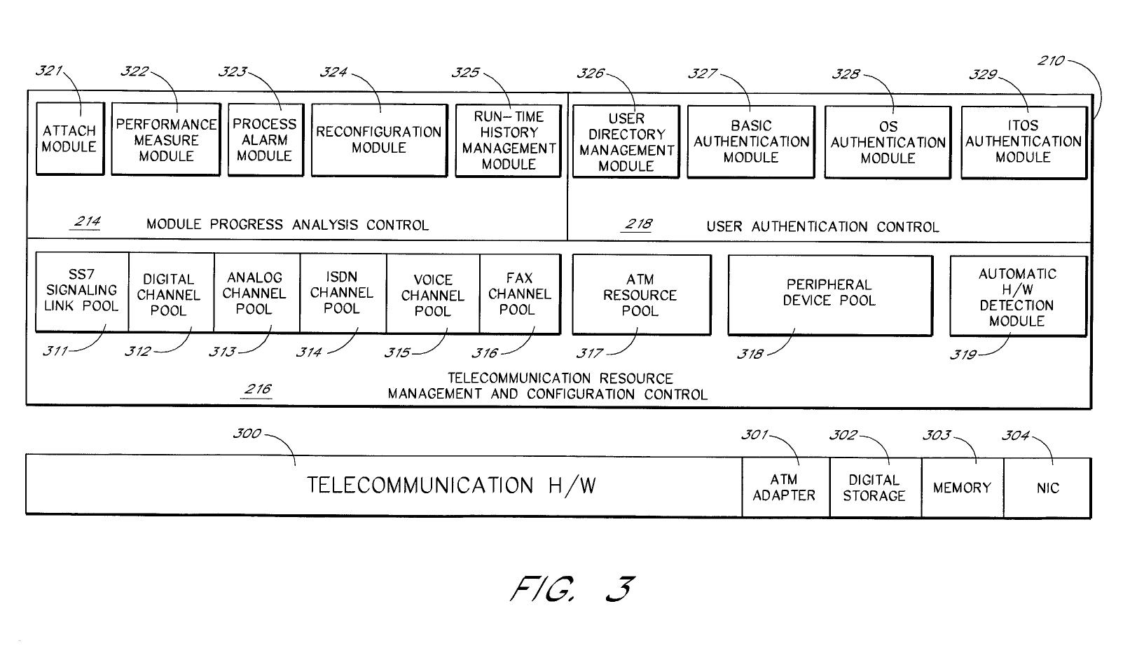

The MPA Control 214 monitors higher-level layer modules and detects abnormalities, such as an overflow, in the higher-level layer modules. Where an abnormality is detected, the MPA Control 214 institutes appropriate remedial measures. The TRMC Control 216 is activated upon boot-up of the iTOS 106 and automatically detects the resident hardware configuration. After detecting the resident hardware, the TRMC Control 216 automatically updates the corresponding virtual resource pool for the detected hardware. Further details of the TRMC Control 216 are described later in connection with FIG. 3. The UA Control 218 allows higher-level applications, such as telecommunications applications, to authenticate users and manage user accounts. Further details of the MPA Control 214, the TRMC Control 216, and the UA Control 218 are also described later in connection with FIG. 3.

The TOS layer 220 coordinates data transfers and other channel transactions between the SI layer 210 and the TSA layer 230. An API from the TSA layer 230 indirectly communicates with remote systems by communicating with the TOS layer 220. In response to a request from an API from the TSA layer 230, the TOS layer 220 relays the request to the SI layer 210, and the TOS layer 220 reports back to the API of the TSA layer 230, the response received from the SI layer 210.

The illustrated TOS layer 220 includes a Local Resource Management (LRM) Control 222, a Telecommunication Packet Switch and Data (TPSD) Control 224 and a Remote Resource Management (RRM) Control 226.

The LRM Control 222 monitors and manages the available local resources by monitoring the resource pools in the TRMC Control 216. The LRM Control 222 reports the status of the availability of the local resources to the TPSD Control 224. The LRM Control 222 further generates the raw data for the Call Detailed Record (CDR), which can be compiled for billing purposes. By flexibly updating the status of available local resources, the LRM Control 222 provides an efficient mechanism to accommodate future system growth and expansion.

The TPSD Control 224 uses the status of the available local resources from the LRM Control 222 to distribute or allocate the available resources among the higher-level telecommunications applications. The TPSD Control 224 further controls or channels the flow of data between the TSA layer 230 and the SI Layer 210.

The RRM Control 226 monitors and manages the available remote resources. The RRM Control 226 reports the status of the availability of the remote resources to the TPSD Control 224. This allows the TPSD Control 224 to compare the resources available in the local resource pool and a remote resource pool, and to allocate the flow of data to remote resource pools when the TPSD Control 224 determines that available resources in the local resource pool are relatively more scarce than available resources from a remote resource pool.

In one embodiment, the RRM Control 226 also maintains the status of the resources at remote systems, even when the remote system is not in the local system's local area network (LAN) or wide area network (WAN). In one embodiment, communication by a local system with remote systems is restricted to remote systems that have been registered by a system administrator, and vice-versa. The registration information can include, for example, identification of a remote system by an IP address, network and domain name, and the like. By using the respective RRM Controls of disparate systems as gateways, a local system obtains the status of a remote system's resources. In one embodiment, resources desired at a remote system are identified and requested by an RRM Control of a local system from the RRM Control of the remote system, which in turn requests the resources from the LRM Control of the remote system. The respective RRM Controls establish the sharing of resources and the local RRM Control communicates the availability of the remote resource to the local LRM Control.

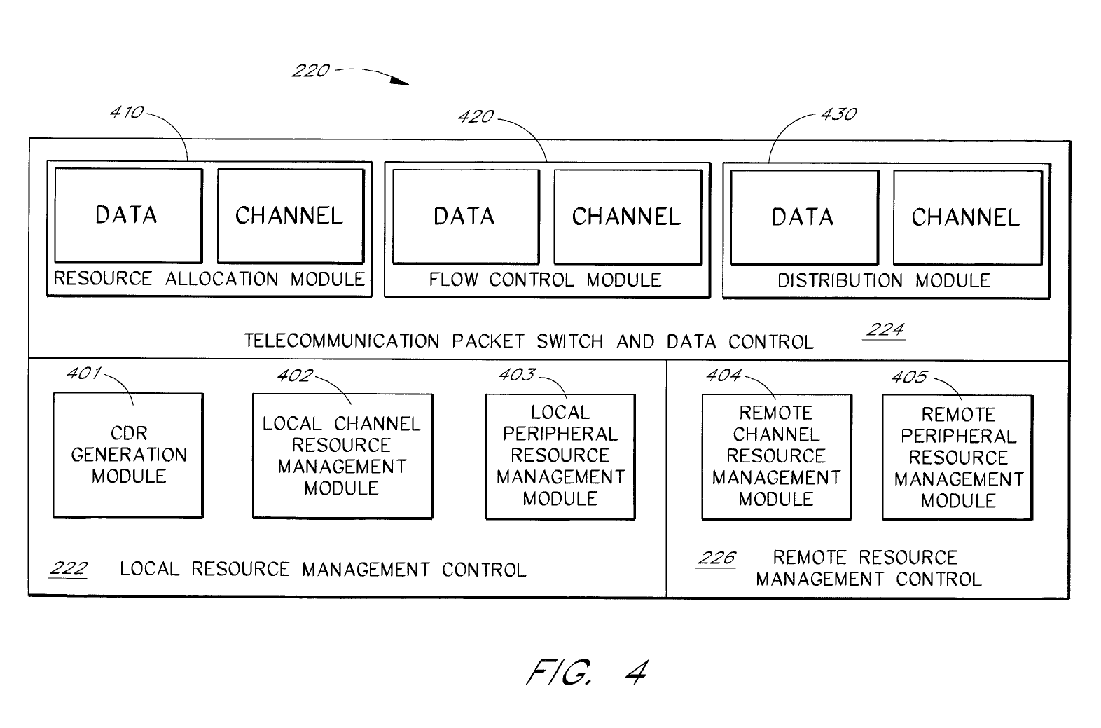

By controlling the data flow at a remote site, the RRM Control 226 can use a remote site to connect a telephone call by transferring the data to the remote site with a function call. Further details of the LRM Control 222, the TPSD Control 224, and the RRM Control 226 are described later in connection with FIG. 4.

In the illustrated iTOS 106, the TSA layer 230 is the highest-level layer. The TSA Layer 230 includes the APIs that enable the telecommunications applications to communicate with the telecommunications hardware through the iTOS. In one embodiment, the TSA Layer 230 can further include resource share definitions that predefine which resources are available to, or correspond with, each higher-level application. In addition, the modules of the TSA layer 230 can communicate with other modules according to an iTOS Messaging Protocol or by a transfer of data to the module. However, where data is transferred outside one system to another system, an iTOS Messaging Protocol is used to translate messages into packets and the like, and to route the packets to the remote system.

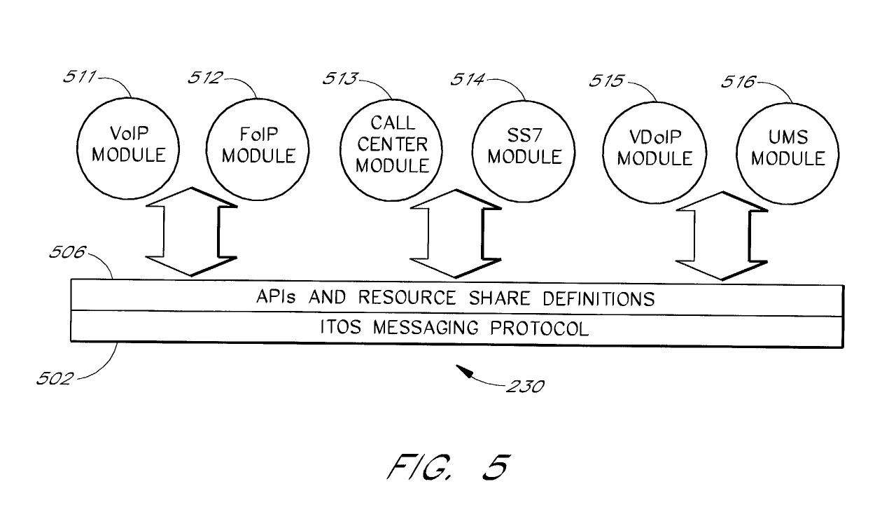

In the illustrated iTOS 106, the TSA layer 230 includes multiple telecommunication service applications 231, a computer client 232, a Voice over Internet Protocol/Fax over Internet Protocol (VoIP/FoIP) 233, a Call Center and Customer Relationship Management (CRM) 234 and a Unified Message System (UMS) 235. Further details of the TSA layer 230 are described later in connection with FIG. 5.

FIG. 3 illustrates Internet telecommunications hardware and one embodiment according to the present invention of a System Integration (SI) layer 210. The Internet telecommunications hardware includes telecommunications hardware 300, such as digital trunk interface boards, analog interface boards, SS7 ITU-T/ANSI signaling boards, voice resource boards, fax resource boards, ATM/TDM interface boards, and the like. The Internet telecommunications hardware further includes peripherals such as an ATM adapter 301, a digital storage 302, a memory 303 and a network interface card (NIC) 304. As described in connection with FIG. 2, the SI layer 210 also includes the MPA Control 214, the TRMC Control 216, and the UA Control 218.

The MPA Control 214 detects abnormalities in higher-level modules and automatically institutes appropriate remedial measures in response to the detected abnormalities. The illustrated MPA Control 214 includes an attach module 321, a performance measure module 322, a process alarm module 323, a reconfiguration module 324, and a run-time history management module 325.

In one embodiment, the MPA Control 214 maintains a log of abnormal events, such as an overflow event, a dropped connection, and the like. When an abnormal event is detected from a higher-level layer module, the MPA Control attempts to resolve the abnormality with reference to a predetermined set of rules. One embodiment allows a system administrator to tailor or define the system's response to an abnormality by permitting tailoring of the rules or by allowing manual intervention. One embodiment further monitors the manual intervention by the system administrator and adds the procedures monitored to automatically create a new correction rule.

In the illustrated iTOS 106, the attach module 321 invokes the appropriate application modules in response to user interaction, and remains attached to the application module while the application module runs. One embodiment uses Windows® messages to communicate with the higher-level application modules. In one embodiment, the attach module operates 321 permits multi-threaded operation, and attaches to running higher-level application modules. The attach module can thereby communicate the status of the higher-level application modules to other modules within the MPA Control 214, such as the performance measure module 322, thereby allowing the other modules to monitor the transactions of a running telecommunications application. The status can be shared via global variables or through Windows® messaging.

The status monitored and reported by the attach module 321 includes parameters such as overall CPU usage, RAM usage, mass storage usage, an identifier for the corresponding thread, an individual process CPU usage, start and stop times for events, abnormal termination information, and the like. In one embodiment, the interaction between the attach module 321 and an application module is defined by the set of APIs that allow the telecommunications applications to communicate with the hardware through the iTOS.

The performance measure module 322 receives status indications from the attach module 321 and measures performance-related parameters in real-time. In one embodiment, the performance measure module 322 preserves or logs indications of the measured performance locally for future analysis. The stored performance indications can be used to measure overall system reliability, to measure the growth in traffic, or the number of users of the system, and determine when to scale or expand the system, and the like.

The process alarm module 323 detects errors such as a buffer overflow, an arithmetic overflow, and the like, by monitoring the status provided by the attach module 321 and provides alarms or reports the errors to related modules that transact with the affected module. The MPA Control 214 tracks the movement of data within the iTOS 106 and can identify the related modules by maintaining records of data transfers. In one embodiment, the process alarm module 323 is configurable to allow a system administrator to set the threshold for an alarm. Upon receiving an alarm, related modules can postpone further processing of data until the error is resolved, inform the user of the error, and the like.

The iTOS 106 can further instigate remedial measures, such as re-initialization, in response to alarms. In the illustrated iTOS 106, the reconfiguration module 324 is notified of the alarm and institutes the remedial measures for the affected module. In one embodiment, the reconfiguration module 324 repairs the error according to predefined rules stored in a database. For example, one predefined rule may specify to re-start the affected module by a re-initialization process. The rule stored in the database may further include information on the messaging formats and the like used to communicate with the affected module.

In another example, where the error is related to a configurable parameter, such as an error due to an insufficient amount of buffer memory in a gateway, rather than reinitialize the gateway, the corresponding rule for the reconfiguration module 324 can specify a response with an increase in size of the buffer memory allocated to the gateway. The new parameter for the buffer memory can be other than that specified by a re-initialization process. In addition, the reconfiguration module 324 can be used with manual intervention and in one embodiment, adaptively learns how to respond to an error by monitoring and replicating the procedures undertaken during manual intervention by a system administrator.

The MPA Control 214 optionally includes the run-time history management module 325, which maintains a history or log of the transactions by iTOS modules to allow system administrators to monitor the system. Such monitoring can be used for debugging and statistical purposes.

The SI layer 210 of the illustrated iTOS 106 further includes the UA Control 218, which allows higher-level applications, such as telecommunications applications, to authenticate users and manage user accounts. Optionally, a single account per user is used for authentication and billing, regardless of the telecommunications application selected by the user. The authentication and billing information maintained by the account can further include privilege levels to restrict access to selected services, to restrict access to certain durations or certain hours, to limit an amount of a resource or a pool used, and the like. By consolidating or integrating the billing associated with a variety of telecommunication services, the UA Control 218 conveniently allows users to monitor charges, review billings, and arrange for payment.

The illustrated UA Control 218 includes a user directory management module 326, a basic authentication module 327, an OS authentication module 328, and an iTOS authentication module 329. The user directory management module 326 manages user accounts and shares the contents of a user account with other systems associated with the telecommunications network. In one embodiment, user accounts are shared with the entire telecommunications operating system network, including network servers and the like, associated with the user's system such that only one user account needs to be maintained to provide the user with telecommunications access throughout the entire network.

In one embodiment, the UA Control 218 allows either unencrypted or encrypted access to complete an authentication process. In the illustrated iTOS 106, the basic authentication module 327 accommodates unencrypted authentication and the iTOS authentication module 329 accommodates encrypted authentication. The dual unencrypted/encrypted access allows the iTOS 106 to provide varying functionality depending upon the type of login.

In response to receiving a valid unencrypted user ID and a password associated with the user, the basic authentication module 327 permits the attach module 321 to activate selected higher-level telecommunications applications by reporting the authentication to the OS authentication module 328. The user's account can be setup so that with an unencrypted login, the user is permitted access with, for example, predetermined resource pool amounts, predetermined billing amounts, restricted times, such as off-peak times, and the like. The user's account can also be setup so that changes to the account details can only be performed in conjunction with an encrypted login process.

The iTOS authentication module 329 authenticates an encrypted user ID and password according to the encryption scheme specified by the iTOS. A valid authentication is reported to the OS authentication module 328, which allows the attach module 321 to activate higher-level telecommunications applications. In one embodiment, changes to a user's account, such as privilege levels, can optionally only be made when the user has accessed the system through an encrypted login process.

The OS authentication module 328 receives an indication from the basic authentication module 327 or the iTOS authentication module 329 of a validly authenticated user. In response to the authentication, the OS authentication module 328 uses the authentication scheme resident on the general operating system 104 to allow an attach module 321 to activate a higher-level telecommunications application.

The SI layer 210 of the illustrated iTOS 106 further includes the TRMC Control 216, which detects the configuration of the resident hardware and manages virtual resource pools for the resident hardware. The TRMC Control 216 includes an automatic hardware detection module 319 and virtual resource pools.

During boot-up of the iTOS 106, the automatic hardware detection module 319 detects the presence of telecommunication devices and the like, and detects the configuration of the resident hardware. In one embodiment, the automatic hardware detection module 319 uses the drivers provided by hardware manufacturers to detect the presence and configuration of the respective hardware. The hardware is further grouped and managed in virtual resource pools by similarity in functionality. In the illustrated embodiment, the TRMC Control 216 allocates the detected hardware among the following groups: a SS7 signaling link pool 311, a digital channel pool 312, an analog channel pool 313, an ISDN channel pool 314, a voice channel pool 315, a fax channel pool 316, an ATM resource pool 317 and a peripheral device pool 318.

In the illustrated iTOS 106, devices such as SS7 ITU-T/ANSI signaling boards are allocated to the SS7 signaling link pool 311. Devices such as T-1 lines, E1 lines, cable modems, DSL, and the like, are allocated to the digital channel pool 312. Devices such as analog interface boards are allocated to the analog channel pool 313. Devices such as ISDN boards are allocated to the ISDN channel pool 314. Devices such as a DTMF tone generation boards, DSP boards, and voice resource boards are allocated to the voice channel pool 315. Devices such as fax resource boards are allocated to the fax channel pool 316. Devices such as ATM/TDM Interface boards are allocated to the ATM resource pool 317. Devices such as NIC adapters, memory and digital storage devices such as disk drives are allocated to the peripheral device pool 318.

The higher-level applications do not communicate directly with the resident hardware to transfer data, but rather, communicate through the iTOS 106. The TOS layer 220 of the iTOS 106 manages data transfer to and from the higher-level applications and the resource pools.

FIG. 4 illustrates one embodiment of the TOS layer 220. The TOS layer 220 transfers data between modules in the SI layer 210 and the TSA layer 230. The TOS layer 220 relays data to and from the API of the TSA layer 230 and the appropriate pool in the SI layer 210. The TOS layer 220 shown in FIG. 4 includes the TPSD Control 224, the LRM Control 222, and the RRM Control 226.

The TPSD Control 224 receives the status of available local resources from the LRM Control 222, allocates the available resources among the higher-level telecommunications applications, and controls data transfers to and from the resources. The illustrated TPSD Control 224 includes a resource allocation module 410, a flow control module 420, and a distribution module 430.

The resource allocation module 410 of the TOS layer 220 allocates the appropriate resources from the resource pools to higher-level applications when requested, and de-allocates resources previously allocated once the resources are no longer needed. The use of virtual resource pools advantageously allows a higher-level application to be developed without prior knowledge of the resident hardware. Where, for example, there is only one respective device for a particular virtual resource pool, the virtual resource pool is still created and maintained by the automatic hardware detection module 319. As new hardware is added for upgrades, repairs, expansion, and the like, the automatic hardware detection module 319 detects the changed hardware with the next system boot-up process or initialization and the iTOS 106 seamlessly provides the higher-level applications with access to the updated virtual resource pools.

In one embodiment, a higher-level application requests a resource from the resource allocation module 410 from within a header in a data packet that is used to transfer data. A request packet, which is a packet from a higher-level application to the iTOS 106, specifies the virtual resource pool desired, such as the SS7 signaling link pool 311, the digital channel pool 312, and the like, also includes the amount of resources to be allocated, and includes the data itself. In addition, the resource allocation module 410 can request additional resources from a remote system when local resources run low or are insufficient for the anticipated data transfer.

The distribution module 430 distributes the resources, including data and channels, allocated by the resource allocation module 410 to the communication application requesting the resource. In one embodiment, a size or amount of each resource pool is computed by the TRMC Control 216 upon boot-up or start-up of the iTOS 106, and the resource allocation module 410 also allocates the available resources to the higher-level applications upon boot-up or initialization. The resource allocation module 410 allocates the resources among the higher-level applications present on the local system. One embodiment further allocates the available resources according to predetermined allocations established for each higher-level application. When resources become scarce during operation, the resource allocation module 410 can adaptively reallocate the resources provided to the respective applications to allow each application to continue to communicate with remote systems.

The flow control module 420 controls the flow of request packets and response packets between the virtual resource pools and the higher-level applications. A response packet is a data packet from a virtual resource pool to a higher-level application and includes an indication of the destination higher-level application in the header of the packet.

The flow control module 420 controls the flow of data to accommodate fluctuating resource levels in the various virtual resource pools. The resource levels in a virtual resource pool can vary with the amount of data that is transferred by the pool, by the operational status of the hardware used to implement the pool, and so forth. In one embodiment, the flow control module 420 reduces the amount or rate of the flow of data to a resource pool in response to an error or an alarm from the resource pool to thereby enable the higher-level applications to continue to communicate with remote systems without interruption.

The LRM Control 222 monitors and manages the resources that are available in the TRMC Control 216. The LRM Control 222 shown includes a CDR generation module 401, a local channel resource management module 402, and a local peripheral resource management module 403.

The CDR generation module 401 maintains a detailed log of calls and other transactions within the iTOS 106. In one embodiment, the CDR generation module 401 monitors the transactions to and from the iTOS 106 and maintains records of the transactions in local storage. The records can include which resources were used, how much of the resources were used, when the resources were used, and the like. The records of the transactions can be retrieved to generate bills, reports, and the like. In one embodiment, the CDR generation module 401 only monitors and logs local transactions and does not monitor remote transactions, relying instead on a similar CDR generation module residing on remote systems to monitor and log their transactions.

In one embodiment, the local channel resource management module 402 manages the local resources that are used for communication in the TRMC Control 216, which include the SS7 signaling link pool 311, the digital channel pool 312, the analog channel pool 313, the ISDN channel pool 314, the voice channel pool 315, the fax channel pool 316, and the ATM resource pool 317.

The local channel resource management module 402 monitors the foregoing local resources and detects when, for example, a local resource is fully utilized or is running relatively low on resources. In one embodiment, the local channel resource management module 402 shares available resources within a pool in response to a resource within the pool becoming fully utilized or otherwise running low on resources. For example, where the voice channel pool 315 includes multiple voice channels, the local channel resource management module 402 switches a relatively heavily loaded voice channel in use by a higher level application to a relatively less heavily loaded voice channel. In another example, where a user's account provides a cap on an allowable bit rates for ATM service, the local channel resource management module 402 drops the use of a particular ATM resource to maintain the allowable bit rate.

In addition, where the local channel resource management module 402 is unable to switch resources within the pool to meet the demand placed on the pool, the shortage of resources is reported to the remote channel resource management module 404. The remote channel resource management module 404 searches for available resources on remote systems and switches the data transfer from the local pool to an available remote resource. In one embodiment, the status of the available resources is communicated with the protocol used by a Primary Domain Controller (not shown).

The local peripheral resource management module 403 detects peripherals associated with the local hardware that are not directly related to communication. As described in connection with the automatic hardware detection module 319, which detects communication related hardware, the local peripheral resource management module 403 similarly detects peripherals with the drivers supplied by the vendors of the respective peripherals. In addition, the local peripheral resource management module 403 also detects the configuration of the peripherals. Such peripherals include mass storage devices such as disk drives, which can be used to maintain transaction information, status, and the like.

The RRM Control 226 monitors and requests remote resources, thereby allowing the LRM Control 222 to allocate data flow to remote resources when locally available resources are scarce. The RRM Control 404 includes a remote channel resource management module 404 and a remote peripheral resource management module 405.

The remote channel resource management module 404 requests status for and allocation of remote communication resources that are related to communication, such as the resources that are analogous to the SS7 signaling link pool 311, the digital channel pool 312, the analog channel pool 313, the ISDN channel pool 314, the voice channel pool 315, the fax channel pool 316, and the ATM resource pool 317 described in connection with FIG. 3.

In one embodiment, the respective remote channel resource management modules 404 of disparate iTOS enabled systems communicate with each other by, for example, the protocol used by a Primary Domain Controller, to inform the requesting system of the status of available resources. Where a resource is available on a remote system, the RRM Control 226 of the remote system retrieves the remote resource from the LRM Control 222 of the remote system. In addition, when resources in a remote system are upgraded or altered in some capacity, the RRM Control 226 of the remote system communicates the change in the resource when requested by the corresponding RRM Control 226 of a system searching for remote resources.

In addition, where remote systems from which resources have been allocated run low on resources or suffer from errors, the remote channel resource management module 404 of the remote system communicates an alarm or the status to the remote channel resource management module 404 of the local system, on which the relevant high-level application resides. The remote channel resource management module 404 of the local system reports the status or alarm to the local MPA Control 214, so that the MPA Control 214 can take remedial action, such as alerting the user or reducing demand on a resource.

The remote peripheral resource management module 405 requests status of and allocation of peripherals from remote systems. The peripherals include components analogous to the ATM adapter 301, the digital storage 302, the memory 303 and the NIC 304 described in connection with FIG. 3. Again, the remote system detects its peripherals using drivers provided by the vendors of the peripherals. In one embodiment, the remote peripheral resource management modules 405 of disparate systems maintain backups of their locally maintained transaction data in each other's systems. The remote peripheral resource management module 405 further maintains an updated status of the peripherals available on remote systems.

FIG. 5 illustrates a TSA layer 230 according to one embodiment of the present invention. The TSA Layer 230 includes the APIs that allow the telecommunications applications to communicate with the hardware through the iTOS. The illustrated TSA layer 230 includes an iTOS messaging protocol 502, a collection of APIs and resource share definitions 506, a VoIP module 511, a FoIP module 512, a call center module 513, an SS7 module 514, a VDoIP module 515, and an UMS module 516. A software developer creates a telecommunication application, such as a VoIP/FoIP application 233, by developing the VoIP module 511 and/or the FoIP module 512, which utilize building blocks from the collection of APIs and resource share definitions 506. In a similar manner, other telecommunications applications, such as the Call Center and CRM 234 and the UMS 235 are created by developing the call center module 513 and the UMS module 516, respectively.

The iTOS messaging protocol 502 provides communication between an API and a lower layer of the iTOS 106, such as the TOS layer 220 or the SI layer 210. The APIs provide the higher-level applications with a relatively constant interface to the iTOS 106. However, the underlying hardware on which the iTOS 106 may be installed can vary greatly from application to application. The iTOS messaging protocol 502 transfers data and function calls from APIs to the corresponding data and function calls used by the lower layers of the iTOS 106 and the hardware.

The APIs and resource share definitions 506 include communication functions used as building blocks or called by the higher-level applications to communicate with the iTOS 106, and subsequently, the local and remote hardware.

The resource share definitions predefine which resources are available to or correspond with each higher-level application, and how an available resource is shared or allocated among the higher-level applications. One embodiment of the iTOS 106 includes APIs with a set of Resource Request functions, Resource Usage functions, Resource De-allocation functions, and Resource Transaction functions. Resource Request functions include functions used in connection with outbound calling, call bridging, call forwarding, and the like. Resource Usage functions include functions that allow a higher-level application to reserve a specific channel, such as a voice channel or a fax channel. Resource De-allocation functions include functions that allow a higher-level application to return a resource that is no longer needed to the resource's pool. Resource Transaction functions include functions that allow the higher-level application to monitor multiple transactions when the higher-level application uses multiple resource at the same time.

Examples of the API include resource request functions, resource usage functions, resource de-allocation functions, resource transaction functions and the like. The resource request functions consist of a set of outbound calling, call bridging and call forwarding functions. The resource usage functions consist of a set of functions used when communication applications receive fax messages through a specific channel or reproduce voice files. The resource de-allocation functions consist of a set of functions of returning used resources to designated pools. The resource transaction functions consist of a set of functions used when a communication application tries to use various resources simultaneously.

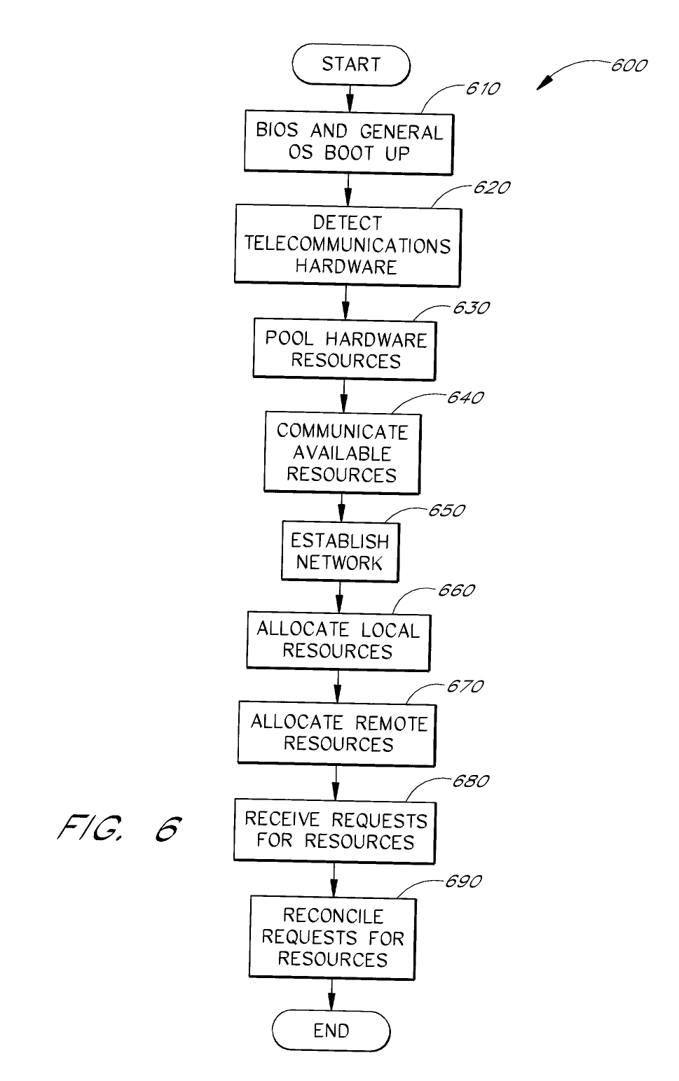

FIG. 6 illustrates an overview process according to one embodiment of the present invention. In State 610, the computer system boots up with the typical ROM BIOS and the resident general OS, which in one embodiment is Windows® NT. In addition, State 610 can include the login process that allows the iTOS 106 to boot up and provide access to the user's higher-level applications. In State 620, the iTOS 106 detects the telecommunications hardware resident in the local system by activating the automatic hardware detection module 319 of the TRMC Control 216. In State 630, the TRMC Control 216 organizes the detected telecommunications hardware and organizes the hardware in to the virtual pools described above in connection with FIG. 3.

In State 640, the TRMC Control 216 reports the status of available resources to the TPSD Control 224. In State 650, the RRM Control 226 of the local system establishes connections with RRM Controls of registered remote systems. In State 660, the TPSD Control 224 allocates the available resources to the higher-level applications. In one embodiment, the available resources and the available higher-level applications vary with the user's login (whether encrypted or unencrypted) and the user's account. In State 670, the TPSD Control 224 allocates the available remote resources where the locally available resources are insufficient or otherwise unavailable.

In State 680, the iTOS 106 receives requests for resources from higher-level applications, such as a VOIP application. In response to a request for a resource, the TPSD Control 224 reserves the available hardware resources and controls data transfers to and from the resources. Where the demand for resources exceeds the availability of resources, in State 690, the LRM Control 222 and the RRM Control 226 of the local system cooperate with the LRM Controls and RRM Controls of remote systems to share resources to resolve resource conflicts.

Thus, as described above, one embodiment of the present invention allows software developers to develop telecommunications applications for the Internet with less effort and with minimal knowledge of the underlying telecommunications hardware on which the telecommunications applications operate as compared to conventional systems. In addition, embodiments of the present invention also permit software developers to create telecommunications applications with a relatively higher degree of portability as compared to conventional systems.

Various embodiments of the present invention have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as defined in the appended claims.

What is claimed is:

1. A method of providing software developers with a stable platform on which a telecommunications application can be developed for a variety of hardware systems, the method comprising:
providing an interface so that a user may log in;
accessing an account associated with the user;
automatically detecting hardware resources resident on a local system that are related to telecommunications;
pooling the detected hardware resources into related virtual pools;
establishing contact with remote systems and obtaining a status of the resources available on the remote systems;
detecting one or more telecommunications applications associated with the user;
allocating the available local resources among telecommunications applications that are associated with the user;
providing an application program interface (API) to a telecommunications applications that enables the telecommunications application to communicate with underlying hardware and remote systems, where the API further automatically compensates for a change in the underlying hardware such that the telecommunications application continues to communicate with the underlying hardware without change to the telecommunications application;
re-allocating available local resources in response to an imbalance between telecommunications-related resources allocated and telecommunications-related resources consumed; and
requesting and receiving resources from a remote system in response to an inadequacy in locally available resources.

2. The method as defined in claim 1, further comprising detecting the presence and configuration of underlying telecommunications hardware with hardware drivers provided by vendors of the respective hardware.

3. The method as defined in claim 1, further comprising activating a telecommunications application through a multi-thread capable attach module, which attaches to at least one telecommunications application to report status of transactions.

4. The method as defined in claim 1, further comprising detecting a change in the underlying hardware and reconfiguring the virtual pools in accordance with the changed hardware.

5. The method as defined in claim 1, further comprising:
detecting an error in a local resource;
alerting a telecommunications application associated with the local resource;
retrieving a repair rule from a database, where the repair rule corresponds to the error; and
reinitializing the local resource in accordance with the repair rule.

6. The method as defined in claim 1, further comprising:
detecting that an error in a local resource;
alerting a telecommunications application associated with the local resource;
alerting a system administrator of the error;
monitoring steps taken by the system administrator to correct the error;
storing the steps in a database as a repair rule; and
retrieving the repair rule and correcting the error in the local resource in response to a subsequent detection of the error.

7. The method as defined in claim 1, further comprising:
detecting an error in a local resource;
alerting a telecommunications application associated with the local resource;
retrieving a repair rule from a database, where the repair rule corresponds to the error;
comparing an initialization allocation from the repair rule to a present allocation of the resource; and
allocating more than the initialization allocation from the repair rule when the present allocation is at least as great as the initialization allocation.

8. The method as defined in claim 1, further comprising:
monitoring and tracking the usage of local resources by a plurality of telecommunications applications;
associating the resources consumed by user; and
computing a bill based on the resources consumed.

9. The method as defined in claim 1, further comprising:
monitoring and tracking the usage of local resources by a plurality of telecommunications applications;
associating the resources consumed by user; and
restricting further access to at least one telecommunications application in response to the resources consumed exceeding a predetermined amount.

10. The method as defined in claim 1, further comprising:
logging events that indicate a shortage of resources;
providing an alert to increase a capacity associated with at least one resource, where the events logged indicate a lack of capacity associated with the resource.

11. The method as defined in claim 1, wherein the contact with the remote systems is established via the Internet.

12. A telecommunications operating system used to manage resources for telecommunication application programs, where the telecommunications operating system works in conjunction with a general operating system, the telecommunications operating system comprising:
a system integration layer that communicates with underlying hardware and the general operating system, where the system integration layer further arranges available hardware resources into virtual resource pools;
a telecommunications service application layer that includes application program interfaces (APIs), which provide protocols and routines that allow a higher-level application to communicate with underlying hardware with a program interface so that the higher-level application is portable from one hardware system to another, where the telecommunications service application layer further includes a messaging protocol that translates and formats data to and from the APIs to a format compatible with the underlying hardware; and
a telecommunications operating system layer that coordinates data transfers to and from the system integration layer and the telecommunications service application layer, the telecommunications operating system layer configured to monitor available resources on the underlying local hardware and on remote systems, the telecommunications operating system layer further configured to allocate available resources among detected local telecommunications applications and configured to reallocate the resources in response to changes in resource demands.

13. The telecommunications operating system as defined in claim 12, wherein the system integration layer further includes a user authentication control configured to receive a user ID and a password to authenticate a first user account.

14. The telecommunications operating system as defined in claim 12, wherein the system integration layer further includes a user authentication control configured to receive an encrypted user ID and an encrypted password to authenticate a second user account.

15. The telecommunications operating system as defined in claim 12, wherein the system integration layer is further configured to detect a presence and a configuration of a telecommunications related hardware by using a hardware driver associated with the hardware.

16. The telecommunications operating system as defined in claim 12, wherein the virtual resource pools comprise a SS7 signaling link pool, a digital channel pool, an analog channel pool, an ISDN channel pool, a voice channel pool, and a fax channel pool.

17. The telecommunications operating system as defined in claim 12, wherein the telecommunications service application layer further includes resource share definitions configured to define how a resource is allocated among available telecommunications applications.

18. The telecommunications operating system as defined in claim 12, wherein the APIs of the telecommunications service application layer are further configured to provide outbound calling, call bridging, and call forwarding functions.

19. The telecommunications operating system as defined in claim 12, wherein the APIs of the telecommunications service application layer are further configured to provide reproduction of voice files.

20. The telecommunications operating system as defined in claim 12, wherein the APIs of the telecommunications service application layer are further configured to receive fax messages functions.

21. The telecommunications operating system as defined in claim 12, wherein the APIs of the telecommunications service application layer are further configured to return an allocation of a pool when a resource is no longer used by a telecommunications application.

22. The telecommunications operating system as defined in claim 12, wherein the telecommunications service application layer further includes at least one higher-level application module adapted to communicate with the APIs to provide a telecommunications application.

23. The telecommunications operating system as defined in claim 12, wherein the telecommunications operating system layer is further configured to receive data from a remote telecommunications application in a data packet, where the data packet includes a header that designates a type of resource pool and an amount of resources from the resource pool.

24. The telecommunications operating system as defined in claim 23, wherein the data packets are transmitted over the Internet.

25. The telecommunications operating system as defined in claim 12, wherein the telecommunications operating system layer further includes a Call Detailed Record generation module configured to monitor and to maintain a record of transactions that use local resources.

26. The telecommunications operating system as defined in claim 12, wherein the telecommunications operating system layer is further configured:
to detect that a resource pool is unable to supply a desired amount of resources for a telecommunications application;
to receive a status of available resources on remote systems; and
to share resources with a remote system to make the remote system resource available to the telecommunications application.

27. The telecommunications operating system as defined in claim 12, wherein the telecommunications operating system layer further includes a local channel resource management module that is configured to detect when a resource within a pool in use by a telecommunications application has run low on available resources, and to switch to the telecommunications application to use another resource within the pool.

28. A system adapted to provide a platform on which telecommunications applications can be layered, the system comprising:
means for providing an interface so that a user may log in;
means for accessing an account associated with the user;
means for automatically detecting hardware resources resident on a local system that are related to telecommunications;
means for pooling the detected hardware resources into related virtual pools;
means for establishing contact with remote systems and obtaining a status of the resources available on the remote systems;
means for detecting one or more telecommunications applications associated with the user;
means for allocating the available local resources among telecommunications applications that are associated with the user;
means for providing an application program interface (API) to a telecommunications applications that enables the telecommunications application to communicate with underlying hardware and remote systems, where the API further automatically compensates for a change in the underlying hardware such that the telecommunications application continues to communicate with the underlying hardware without change to the telecommunications application;
means for re-allocating available local resources in response to an imbalance between telecommunications-related resources allocated and telecommunications-related resources consumed; and
means for requesting and receiving resources from a remote system in response to an inadequacy in locally available resources.
